(19) United States
(12) Patent Application Publication
(10) Pub. No.: US 2014/0297744 A1
(43) Pub. Date: Oct. 2, 2014

(54) REAL-TIME SUPPLEMENT OF SEGMENTED DATA FOR USER TARGETING

(71) Applicant: MICROSOFT CORPORATION, Redmond, WA (US)

(72) Inventors: Filip Lazar, Redmond, WA (US); Chandan Kapoor, Redmond, WA (US); Graeme Roche, Seattle, WA (US)

(73) Assignee: Microsoft Corporation, Redmond, WA (US)

(21) Appl. No.: 13/855,633

(22) Filed: Apr. 2, 2013

(51) Int. Cl. H04L 12/58

(52) U.S. Cl. CPC H04L 51/04
USPC 709/204

(57) ABSTRACT

The present disclosure describes a method that includes retrieving segmented data relating to a selected factor concerning a user, retrieving real-time data relating to the selected factor, and providing a communication to the user if both the segmented data and the real-time data meet one or more preselected conditions.

### BACKGROUND

Segmented data refers to subsets of data that are identified from supersets of linked data, such as one or more databases, through processes known as data mining, regression, decision tree learning, etc. Segmented data is sometimes used to make targeted offers or other communications to customers, users, etc.

The generation of segmented data is computationally-intensive and is typically performed as a batch process that can require time on the scale of hours, or even days. As a consequence, there is typically a significant corresponding latency in segmented data with respect to changes in the underlying data, and targeted offers or other communications that are based on segmented data are sometimes redundant, untimely, or irrelevant because of intervening changes or events.

### SUMMARY

This Summary introduces in a simplified form a selection of features that are further described below in the Detailed Description. This Summary is not intended to identify key features or essential features of the claimed subject matter and is not intended to be used to limit the scope of the claimed subject matter.

Real-time supplementation of segmented data provides efficient user or customer targeting by eliminating targeting events that are rendered redundant by information changes between updates of the segmented data. In one embodiment, a method includes retrieving segmented data relating to a selected factor concerning a user, retrieving real-time data relating to the selected factor, and providing a communication (e.g., an offer) to the user if both the segmented data and the real-time data meet one or more preselected conditions.

Additional aspects and advantages of real-time supplementation of segmented data will be apparent from the following detailed description, which proceeds with reference to the accompanying drawings.

### DRAWINGS DESCRIPTION

FIG. 1 is a flow diagram of a computer-implemented segmented data supplementation method.

FIG. 2 is a diagrammatic illustration of a user interface sequence of a segmented data supplementation method.

FIG. 3 is a block diagram of a segmented data and real-time supplement system.

FIG. 4 is a flow diagram of a segmented data and real-time supplement operating method.

FIG. 5 is a block diagram of a system having a computing device as an operating environment of one or more embodiments described above.

### DETAILED DESCRIPTION

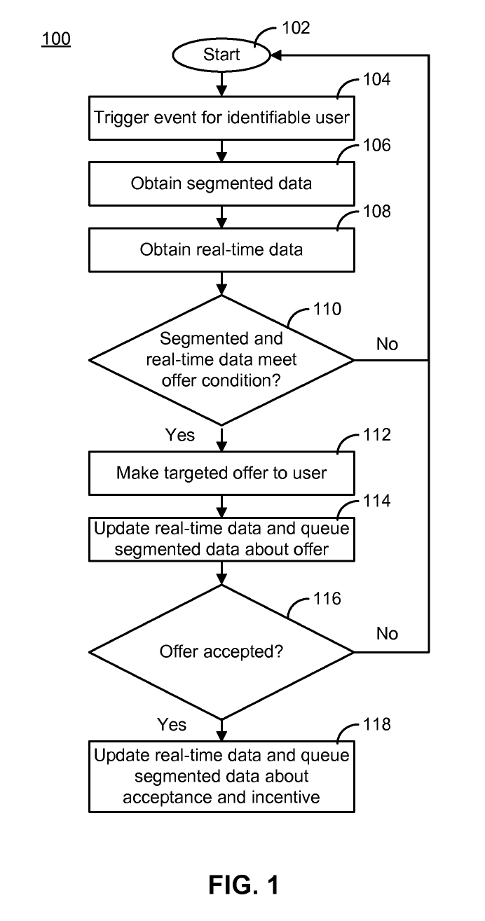

FIG. 1 is a flow diagram of a computer-implemented segmented data supplementation method 100 for supplementing batch-processed segmented data with real-time data updates. Segmented data refers to a data subset that is identified from a superset of linked data, such as one or more source tables or databases, through one or more processes such as data mining, regression, decision tree learning, etc. Real-time data updating refers to changes that are reflected as they occur, generally within the constraints of times needed for data transmission and receiving and storing data record changes, but between the episodic batch-processing of the segmented data.

Method 100 is described, for example, with reference to making a targeted communication (e.g., offer) to a user or customer or prospect based upon a real-time supplement of segmented data. It will be appreciated that method 100 may also be used in other contexts and applications in which real-time supplementation of segmented data can provide increased efficiency by reducing or eliminating redundant actions that would otherwise be taken upon segmented data that is rendered inaccurate or untimely by intervening real-time events. Method 100 begins with start block 102.

Step 104 indicates that a trigger event occurs with regard to an identifiable user. For example, the identifiable user may access a particular network site (e.g., a Web site), activate a network-access or application, or the like, all of which are generally referred to as a “service.” It will be appreciated that the user may be identifiable with regard to personal identity information (e.g., name, home or work address, etc.) or online identity information (e.g., username, email address, etc.).

Step 106 indicates that segmented data relating to the user is obtained, if available. The segmented data may include one or more data fields relating to the user. For example, the segmented data may relate to demographic information (e.g., gender, age, etc.) about the identifiable user or historical information indicating whether the identifiable user has purchased a product or service, has accessed or established an account at a network site, has downloaded or activated an application, or any other types of information.

Step 108 indicates that real-time supplemental data relating to the user is obtained, if available. The real-time supplemental data, sometimes called real-time data, may relate to the same subject matter as the segmented data, or to different subject matter that bears a relation or connection to the segmented data or the targeted communication.

Decision step 110 represents a query whether the segmented data and the real-time data meet an offer condition. If the segmented data and the real-time data relate to the same subject matter, the same condition could be applied to both the segmented data and the real-time data. For example, the segmented data and the real-time data could both query whether the user has downloaded an application, and the same condition could be applied to both sets of data (e.g., “has the user downloaded an application?”). Also, different conditions can be applied to the segmented data and the real-time data if they relate to different subject matter. For example, the segmented data could indicate whether the user has downloaded an application, the real-time data could indicate whether the user has been provided an offer of the application, and different conditions could be applied to the segmented data (e.g., “has the user downloaded the application?”) and the real-time data (e.g., “has the user been offered the application?”). If the segmented data and the real-time data do not meet the offer condition, decision step 110 returns to start block 102. If the segmented data and the real-time data meet the offer condition, decision step 110 proceeds to step 112.

Step 112 indicates that a targeted offer is made to the user. For example, the offer is sent or provided to the user at a computing device (e.g., computer, mobile telephone, network access device, etc.). The offer may be in any format that can be rendered by the computing device and is discernible by the user, including text, graphics, audio or video, as a distinct message (e.g., email, SMS text message, etc.), a nested message (e.g., a pop-up window, scrolled message bar, etc.), or a separate network page, etc., whether displayed immediately by the computing device (e.g., pop-up window) or subsequently accessible by the user when accessing another network service (e.g., email).

The offer is targeted in that it relates to a selected aspect of the identifiable user and may relate to the user purchasing a product or service, accessing, establishing, or modifying an account at a network site, downloading or activating an application, etc. The offer may stand alone or may be associated with or include a reward, benefit, etc. (referred to as an “incentive”) to motivate the user to accept the offer.

Step 114 indicates that the real-time data is updated and an update of the segmented data is queued with respect to the targeted offer being made to the user.

Decision step 116 represents a query whether the user accepts the targeted offer. Decision block 116 proceeds to step 118 if the user accepts the targeted offer, and decision block 116 returns to start block 102 if the user does not accept the targeted offer. Acceptance may be an explicit indication of acceptance from the user or may be implicitly manifested by the user taking an action implementing, accessing, etc. the offered feature.

Step 118 indicates that the real-time data is updated with regard to acceptance of the offer, and an update is queued for incorporation into the segmented data, including an indication of any incentive being provided to the user. Step 118 returns to start block 102.

An aspect of method 100 is that it combines the effectiveness of a targeted action based on segmented data with the positive reinforcement provided by a timely, relevant incentive supported by real-time data. The use of segmented data alone can lack reinforcement timeliness while the awarding of an incentive is delayed until segmented data is updated. The use of real-time incentives alone can lack the efficiency of a targeted offering.

By way of example, method 100 is described with reference to one targeted offer being made to a user. Method 100 may also be applied as multiple successive related offers. In this context, offers and incentives may build upon one another, even providing a gamification of the relationship between successive offers, incentives, and acceptances employing segmented and real-time data.

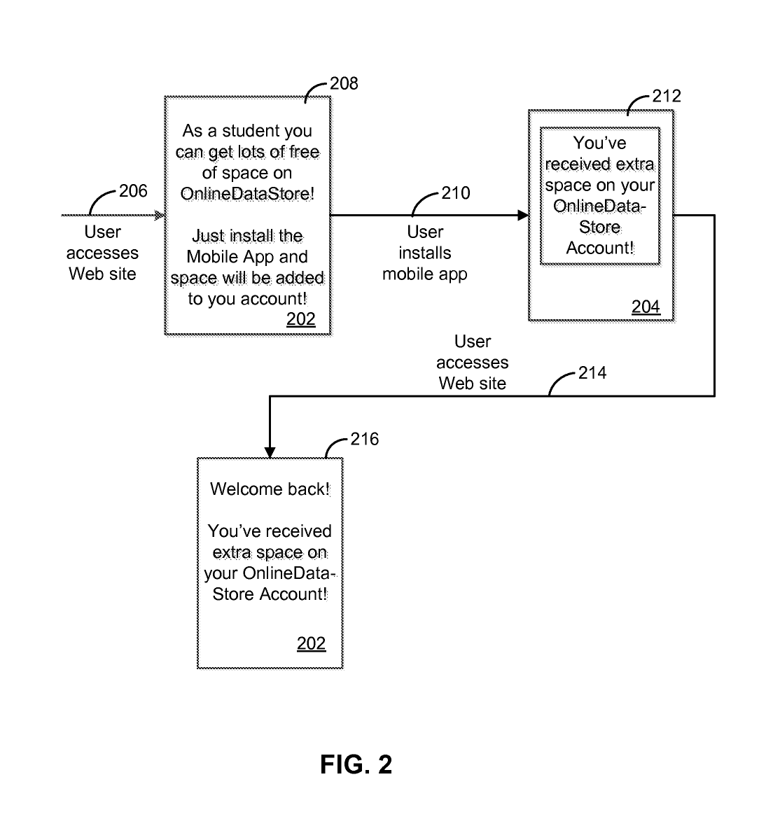

FIG. 2 is a diagrammatic illustration of a user interface sequence of a segmented data supplementation method in which a targeted offer is made to a user or customer in a cross-platform operating environment. The operating environment includes a first computing device 202 of a first computing platform and a second computing device 204 of a second computing platform, and the user may use either or both of computing devices 202 and 204 at different times, or the same time. In this example, an offer is made to the user regarding a feature, service, application, etc. for computing device 204 while the user is using computing device 202. For example, computing device 202 may be a computer (e.g., desktop, notebook, tablet, etc.) of a first operating system accessing a Web site, and computing device 204 may be a mobile computing device (e.g., a smartphone or another type of mobile computing device) of a second operating system, different from the first.

Step 206 indicates that the user accesses a Web site, the access operating as a trigger event for an offer, including an incentive. Display 208 shows an offer being rendered on computing device 202 regarding a feature for use with computing device 204, the offer including an incentive. In this example, the Web site relates to a hypothetical online data storage service (i.e., “OnlineDataStore”) with which the user already has an account, the offer relates to the user installing on computing device 204 a “mobile app” relating to the service, and the incentive relates to increasing the resources (e.g., data storage capacity) allocated to the user's account. As an example, the offer rendered in display 208 may be based upon segmented and real-time data meeting offer conditions such as the following:
HasMobileApp?=no
Is Student?=true
Offer last presented >7 days ago=true
Times of OnlineDataStore Use in last 15 days=10

Step 210 indicates that the user installs the offered feature on computing device 204, thereby indicating acceptance of the offer. As an example, acceptance of the offer may result in an update of real-time data such as the following:
Set HasMobileApp=true
Has been asked in last 7 days=true

Display 212 shows an updated indication on computing device 204 that the incentive has been awarded. For example, display 212 may be rendered when the user first activates the offered feature or service. Step 214 indicates that the user returns to the Web site on computing device 202. Display 216 shows an indication on computing device 202 confirming that the incentive has been awarded.

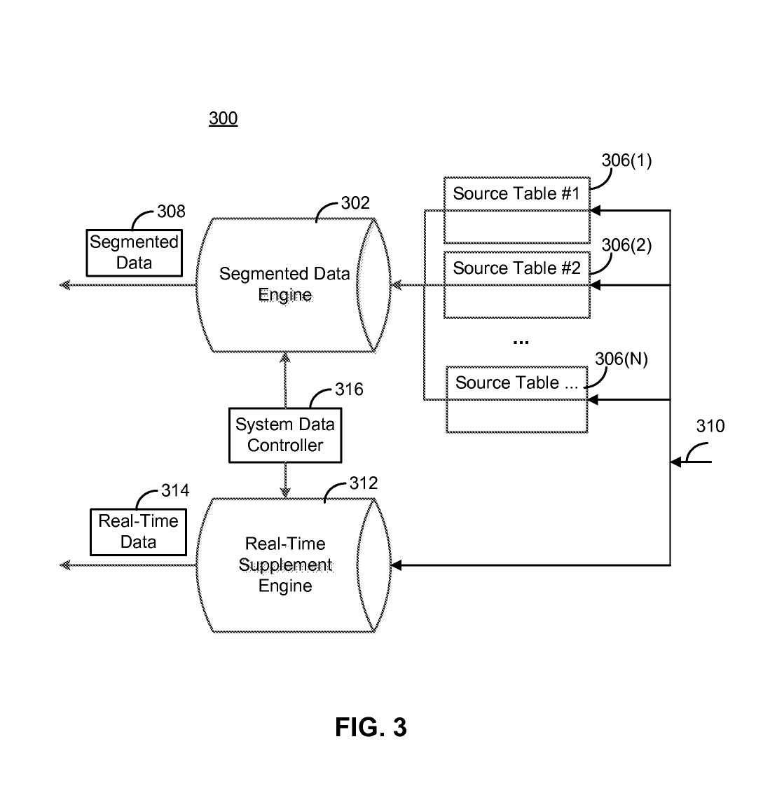

FIG. 3 is a block diagram of a segmented data and real-time supplement system 300. System 300 includes a segmented or segmentation data engine 302 that operates on a data superset 304 that may include one or more source tables 306(1)-306(N) (e.g., databases) using one or more processes such as data mining, regression, decision tree learning, etc. to generate segmented data 308. Source tables 306 receive data updates at a data input 310. Generation of segmented data 308 is typically performed as an episodic (e.g., periodic) batch process, so segmented data 308 typically would not include data updates that occur between data segmentation operations.

A real-time supplement engine 312, also connected to input 310, provides storage of and access to real-time data 314 corresponding to data updates that occur between the data segmentation operations of segmented data engine 302. Real-time data updating refers to data changes that are reflected as they occur, generally within the constraints of times needed for data transmission and receiving and storing data record changes, and can be current during times between the episodic generation of segmented data 308. In one implementation, data in real-time supplement engine 312 is incorporated into segmented data 308 during each data segmentation operation of segmented data engine 302 and is then cleared from real-time supplement engine 312 to reduce its data load. As a result, real-time supplement engine 312 in this implementation stores data updates occurring between successive data segmentation operations. It will be appreciated that the clearing of data from real-time supplement engine 312 could alternatively occur at other times.

A system data controller 316 controls queries and retrieval of data from system 300. Controller 316 implements data queries and offer conditions to determine whether data from segmented data engine 302 and real-time supplement engine 312 is available and meets offer conditions. Data controller 314 determines, for example, whether segmented data 308 and real-time data 314 meet an offer condition.

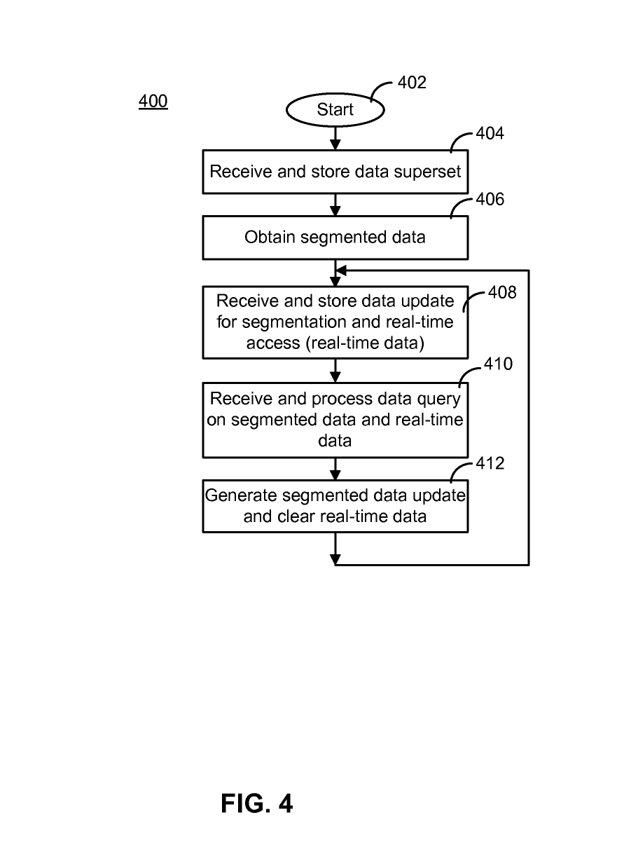

FIG. 4 is a flow diagram of a segmented data and real-time supplement operating method 400. Method 400 begins with start block 402.

Step 404 indicates that a superset of linked data is received and stored. For example, the superset of linked data may be stored in one or more source tables.

Step 406 indicates that a data segmentation operation is performed on the superset of data to obtain segmented data.

Step 408 indicates that a data update is received and stored for subsequent data segmentation and for real-time access as real-time data.

Step 410 indicates that a data query is received and processed with regard to the segmented data and the real-time data, including any updating of the real-time data based upon the processing of the query.

Step 412 indicates that a segmented data update is generated and the real-time data is cleared. For example, a data segmentation operation is performed on the superset of data, including updates corresponding to the real-time data, to obtain updated segmented data. The real-time data, now being incorporated into the updated segmented data, is cleared to make way for any new real-time data that is received before the next segmented data update.

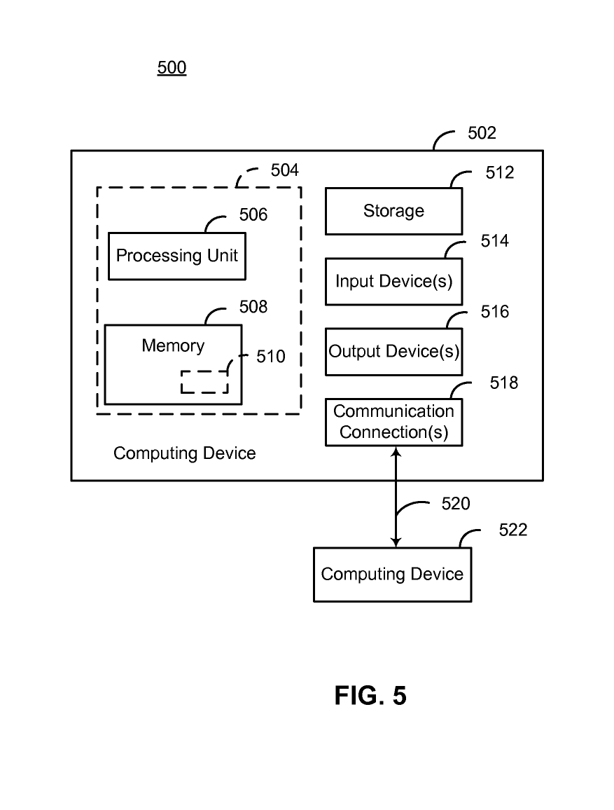

FIG. 5 is a block diagram of a system 500 having a computing device 502 as an operating environment of one or more embodiments described above. Computing device 502 includes a basic computing structure 504 having a processing unit 506 and a memory 508. Processing unit 506 executes or performs software or other computer-executed instructions 510 stored in memory 508 in accordance with operations described above. Processing unit 506 may include one or more of any of a central processing unit, a co-processor, and a dedicated or special-purpose processing unit (e.g., an audio processor). Memory 508 may include one or both of volatile memory (e.g., registers, cache, RAM) and non-volatile memory (e.g., ROM, EEPROM, flash memory), and may include one or more portions that are integrated with processing unit 506 or distinct from it. Memory 508 stores software or other computer-executed instructions 510 that are executed or executable by processing unit 506, and may also store other data or information.

Computing device 502 may also include any or all of the following additional components: storage 512, one or more input devices 514, one or more output devices 516, and one or more communication connections 518. An interconnection mechanism (not shown), such as a bus, controller, or network, interconnects the components of computing device 502. Typically, operating system software (not shown) provides an operating environment for software executed or performed by computing device 502 on and coordinates operation of its components.

Storage 512 may include portions that removable or non-removable and may include magnetic storage, optical storage, or electrical storage that may be local to or remote from basic computing structure 504. In one embodiment, software 510 and the operating system software may be stored in both memory 508 and storage 512, with software 510 and the operating system software being loaded in memory 508 from storage 512 for execution by processing unit 506.

To the extent used herein, the terms “computer readable medium” and “computer readable media” generally refer to any and all forms of memory 508 and storage 512 and may be volatile or nonvolatile, removable or non-removable, and by way of example and not limitation may include any or all of the following types: RAM, ROM, EEPROM, flash memory, or other memory circuit technologies, CD-ROM, Digital Versatile Disks (DVDs) or other optical storage, magnetic storage devices such as disks, tapes, cassettes, etc., but shall not include or refer to propagating signals

Input device or devices 514 may include one or more of: keyboard, keypad, touchscreen, touchpad, mouse, trackball, pen, voice input device, camera, scanner, or any other input device. Output device(s) 516 may include one or more of: display, speaker, printer, motion or action actuator or activator, transmitter, or any other output device. Each input device 514 and output device 516 may be connected to or communicate with computing device device 502 via any wired or wireless connection employing any optical, electrical, electromagnetic, or acoustic communication.

Computing device 502 communicates through communication connection or connections 518 over a communication medium 520 with one or more other computing devices 522. Communication medium 520 carries information, such as data, computer-executable instructions, audio or video information, or other information, between computing devices 502 and 522. By way of example, communication medium 520 may include direct or networked communication between computing devices 502 and 522 and may include one or more of wired or wireless connections employing electrical, optical, electromagnetic, acoustic, or other carriers. As one example, communication medium 520 may include a global computer network such as the Internet.

A person of ordinary skill in the art will recognize that many changes may be made to the details of the above-described exemplary embodiments without departing from the underlying principles. Only the following claims, therefore, define the scope of real-time supplement of segmented data for user targeting described herein.

1. A computer-implemented method, comprising:
retrieving from a segmentation data source segmented data relating to a selected factor concerning a user;
retrieving from a real-time data supplement source real-time data relating to the selected factor; and
providing a communication to the user if the segmented data and the real-time data meet one or more preselected conditions.

2. The computer-implemented method of claim 1 in which the selected factor relates to use by the user of a first computing device associated with a first computing platform.

3. The computer-implemented method of claim 1 in which the selected factor relates to implementation of a feature on the first computing device.

4. The computer-implemented method of claim 2 in which the communication includes an offer and the method further comprises:
receiving an indication of user implementation of the offer on the first computing device;
updating the real-time data supplement source in real-time to indicate the user implementation of the offer; and
queuing the indication of user implementation of the offer for batched incorporation into the segmented data.

5. The computer-implemented method of claim 4 further comprising providing the user an incentive for implementation of the offer.

6. The computer-implemented method of claim 2 in which the communication is provided to the user at a second computing device associated with a second computing platform different from the first computing platform while the user accesses a first service from the second computing device.

7. The computer-implemented method of claim 6 further comprising retrieving the segmented data and the real-time data each of plural times the user accesses the first service.

8. The computer-implemented method of claim 6 in which the first service includes a Web site.

9. The computer-implemented method of claim 2 in which the first computing device includes a mobile device.

10. A computer-implemented method, comprising:
retrieving from a segmentation data source segmented data relating to a selected factor concerning use by a user of a first computing device associated with a first computing platform;
retrieving from a real-time data supplement source real-time data relating to the selected factor;
providing an offer to the user if the segmentation data and the real-time data meet one or more preselected conditions, the offer being provided to the user at a second computing device associated with a second computing platform different from the first computing platform while the user accesses a first service from the second computing device; and
providing the user an incentive for implementation of the offer.

11. The computer-implemented method of claim 10 further comprising:
receiving an indication of user implementation of the offer on the first computing device;
updating the real-time data supplement source in real-time to indicate the user implementation of the offer; and
queuing indication of user implementation of the offer for batched incorporation into the segmentation data source.

12. The computer-implemented method of claim 10 further comprising retrieving the segmented data and the real-time data each of plural times the user accesses the first service.

13. The computer-implemented method of claim 10 in which the first and second computing platforms relate to different operating systems.

14. The computer-implemented method of claim 10 in which the first service includes a Web site.

15. The computer-implemented method of claim 10 in which the first computing device includes a mobile device.

16. The computer-implemented method of claim 10 in which the selected factor relates to implementation of a feature on the first computing device.

17. A computer-implemented method, comprising:
retrieving from a segmentation data source segmented data relating to a selected factor concerning a user;
retrieving from a real-time data supplement source real-time data relating to the selected factor;
providing an offer to the user if the segmented data and the real-time data meet one or more preselected conditions;
updating in real-time the real-time data supplement source and a source table queue with a change in the data relating to the selected factor, the source table queue queuing data for batched incorporation into the segmentation data source.

18. The computer-implemented method of claim 17 further comprising deleting from the real-time data supplement source the change in the data when after it is batch incorporated into the segmentation data source.

19. The computer-implemented method of claim 17 in which the selected factor relates to use by the user of a first computing device associated with a first computing platform and the change in the data corresponds to user implementation of the offer on the first computing device.

20. The computer-implemented method of claim 19 in which the offer is provided to the user at a second computing device associated with a second computing platform different from the first computing platform.
